(19) United States
(12) Patent Application Publication
(10) Pub. No.: US 2012/0154627 A1
(43) Pub. Date: Jun. 21, 2012

(54) Systems and methods for controlling color balance for a photographic illuminator

(76) Inventors: William Rivard, Menlo Park, CA (US); Brian Kindle, Sunnyvale, CA (US)

(21) Appl. No.: 12/928,877

(22) Filed: Dec. 20, 2010

(51) Int. Cl. H04N 9/73

(52) U.S. Cl. 348/224.1; 348/E09.051

(57) ABSTRACT

A system and method for generating controlled illumination having a color balance that corresponds to prevailing ambient color balance. A multi-spectral light source having a given spectral characteristic is filtered through an active color filter to produce multi-spectral light conforming to the prevailing ambient color balance. Embodiments of the present invention advantageously enable photographic capture of images without introducing color balance inconsistencies seen in prior art illumination solutions.

### BACKGROUND OF THE INVENVTION

1. Field of the Invention

Embodiments of the invention relate generally to photographic lighting systems, and more specifically to systems and methods for controlling color balance for a photographic illuminator.

2. Description of the Related Art

Photographic recording conventionally involves projecting a scene image through a lens assembly onto a sampling surface. The scene image represents a section of a scene, as projected and focused by the lens assembly. The sampling surface may be a frame of photographic film or an electronic image sensor configured to sample the scene image for electronic storage. The scene image may be stored as a two-dimensional field of chemical state in the frame of photographic film or as electronic state in a digital memory subsystem. The process of sampling ultimately produces a photographic image representing the scene image. Sampling period (shutter speed), lens aperture, and sampling sensitivity (conventionally referred in terms of an “ISO” index of sensitivity) determine overall image exposure. Proper exposure for the photographic image is based on attempting to emulate natural human visual perception, which is highly adaptive over a large dynamic range. Human visual perception is highly efficient at maximizing perceived tonal balance, and therefore a properly exposed photographic image exhibits good tonal balance. Modern digital cameras can generally achieve good tonal balance and proper exposure in recording photographic images.

In certain scenarios, ambient lighting within a scene is inadequate to produce a properly exposed photographic image of the scene or certain subject matter within the scene. In certain other scenarios, an additional light source from one or more directions may aesthetically improve or highlight certain aspects of a subject being photographed within the scene. In one example scenario, a photographer may wish to photograph a person (subject) at night in a setting that is inadequately illuminated by incandescent or fluorescent lamps. A photographic strobe may be used to beneficially provide additional light on the subject to achieve a desired exposure, however the color balance (ratios of red, green, and blue light) of the strobe will not match that of the ambient incandescent or fluorescent lighting.

Human visual perception also dynamically adapts to ambient illumination color to enable proper perception of color despite off-white ambient illumination. For example, a white sheet of paper is commonly perceived as being white regardless of whether the paper is illuminated by inherently white sunlight or inherently orange candlelight. A modern digital camera is typically configured to be able to compensate for ambient illumination color in order to reproduce overall correct colors for the scene. In this way, the camera attempts to emulate human visual perception with respect to white balance. Alternatively, white balance of a digital photograph may be achieved via post processing. Persons skilled in the art will recognize that color balance for a photographic image is conventionally accomplished by modifying channel gain for each one of red, green, and blue color channels over the entire photographic image to compensate for overall scene color.

One challenge of color photography is that a given scene may have multiple different light sources, each characterized by different color balances. In such a scene, achieving white balance that appears correct can be quite difficult. For example, an incandescent lamp is characterized as emitting significantly more red light than blue light, while a conventional Xenon photographic strobe emits a relatively even mix of red, green, and blue light. If the digital camera uses a color balance based on ambient incandescent or sunset lighting, then objects predominantly illuminated by the ambient lighting will be properly color balanced, while objects that are predominantly illuminated by the strobe will appear overly blue. Alternatively, if the camera assumes a color balance corresponding to the strobe color balance, then objects that are predominantly illuminated by ambient lighting will appear overly red. Because the Xenon photographic strobe produces an inherently different balance of light compared to the ambient light, achieving a realistic white balance is oftentimes impractical while photographing such scenes.

As the foregoing illustrates, what is needed in the art is a technique for properly illuminating a scene according to existing ambient color balance.

### SUMMARY OF THE INVENTION

One embodiment of the present invention sets forth a method for generating color illumination having a target color balance, the method comprising the steps of determining the target color balance, generating a transmission factor for each color channel of a plurality of color channels within an active color filter based on the target color balance and color characteristics of an illumination source, and activating each color channel of a plurality of color channels based on the corresponding transmission factor to transmit illumination having the target color balance.

Another embodiment of the present invention sets forth a system for generating color illumination having a target color balance, the system comprising an active color filter, configured to selectively transmit different color components of source illumination based on corresponding transmission factors, and a controller. The controller is configured to determine the target color balance, generate a transmission factor for each color channel of a plurality of color channels within the active color filter based on the target color balance and color characteristics of the source illumination, and to activate the active color filter using a control signal representing the transmission factors.

A further embodiment of the present invention sets forth a portable photographic system, the system comprising a digital camera subsystem configured to sample and store photographic images, a multi-spectral light source, configured to provide the source illumination when triggered by the digital camera subsystem, an active color filter, configured to selectively transmit different color components of the multi-spectral light source based on corresponding transmission factors, and a controller. The controller is configured to determine the target color balance, generate a transmission factor for each color channel of a plurality of color channels within the active color filter based on the target color balance and color characteristics of the multi-spectral light source, and to activate the active color filter using a control signal representing the transmission factors.

The present invention enables photographers to advantageously illuminate photographic scenes with appropriately color balanced light, resulting in higher quality, more natural looking photographs.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1A illustrates a color compensated flash unit, according to one or more aspects of the present invention;

FIG. 1B illustrates a functional diagram of the color compensated flash unit of FIG. 1A, according to one embodiment of the present invention;

FIG. 2A illustrates a color compensation unit configured to attach to a separate flash unit, according to one embodiment of the present invention;

FIG. 2B illustrates the color compensation unit attached to the separate flash unit, according to one embodiment of the present invention;

FIG. 2C illustrates a filter unit and control unit coupled to the separate flash unit, according to one embodiment of the present invention;

FIG. 2D illustrates a functional diagram of the color compensation unit, according to one embodiment of the present invention;

FIG. 3A illustrates a digital camera configured to implement one or more aspects of the present invention;

FIG. 3B illustrates a side detail of the digital camera, according to one embodiment of the present invention;

FIG. 3C illustrates a functional diagram of a color compensated flash module within the digital camera, according to one embodiment of the present invention;

FIG. 3D illustrates a front view of a mobile wireless device configured to implement one or more aspects of the present invention;

FIG. 3E illustrates a functional diagram of the mobile wireless device, according to one embodiment of the present invention;

FIG. 4A illustrates a detailed view of an active color filter, according to one embodiment of the present invention;

FIG. 4B depicts a side view of a pixel array, according to one embodiment of the present invention;

FIG. 4C depicts a response curve of light transmission as a function of applied voltage for a cell within the pixel array, according to one embodiment of the present invention;

FIG. 5A illustrates the pixel array configured to include color filters for red, green, and blue, according to one embodiment of the present invention;

FIG. 5B illustrates the pixel array configured to include color filters for red, green, blue, cyan, magenta, and yellow according to one embodiment of the present invention;

FIG. 5C illustrates the pixel array configured to include color filters for red, green, blue, cyan, magenta, and yellow according to an alternative embodiment of the present invention;

FIG. 5D illustrates the pixel array configured to include color filters for cyan, magenta, yellow, and white according to one embodiment of the present invention

FIG. 5E depicts an ideal band pass color filter as a function of wavelength (λ), and centered at λ₀;

FIG. 5F depicts a typical physical realization of a band pass color filter as a function of wavelength (λ), and centered at λ₀;

FIG. 6 illustrates a technique for controlling multiple levels of transmission within the active color filter, according to one embodiment of the present invention;

FIG. 7 is a conceptual diagram of a color compensated flash unit comprising functional blocks for measuring ambient color balance and filtering a multi-spectral light signal to generate a controlled illumination signal based on ambient color balance, according to one embodiment of the present invention;

FIG. 8A is a flow diagram of method steps for generating controlled illumination based on measured ambient color, according to one embodiment of the present invention;

FIG. 8B is a flow diagram of method steps for generating controlled illumination based on a specified color balance, according to one embodiment of the present invention.

### DETAILED DESCRIPTION

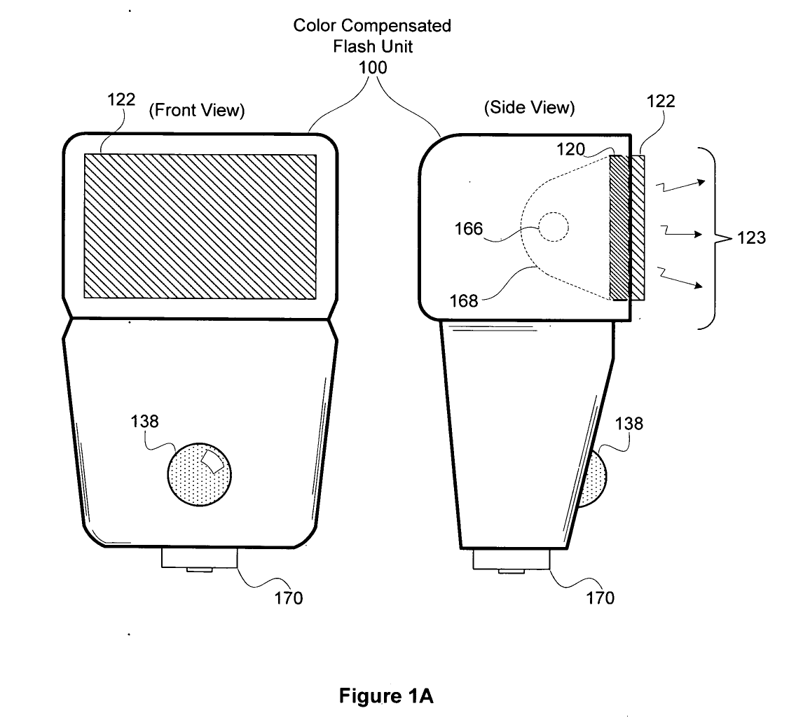

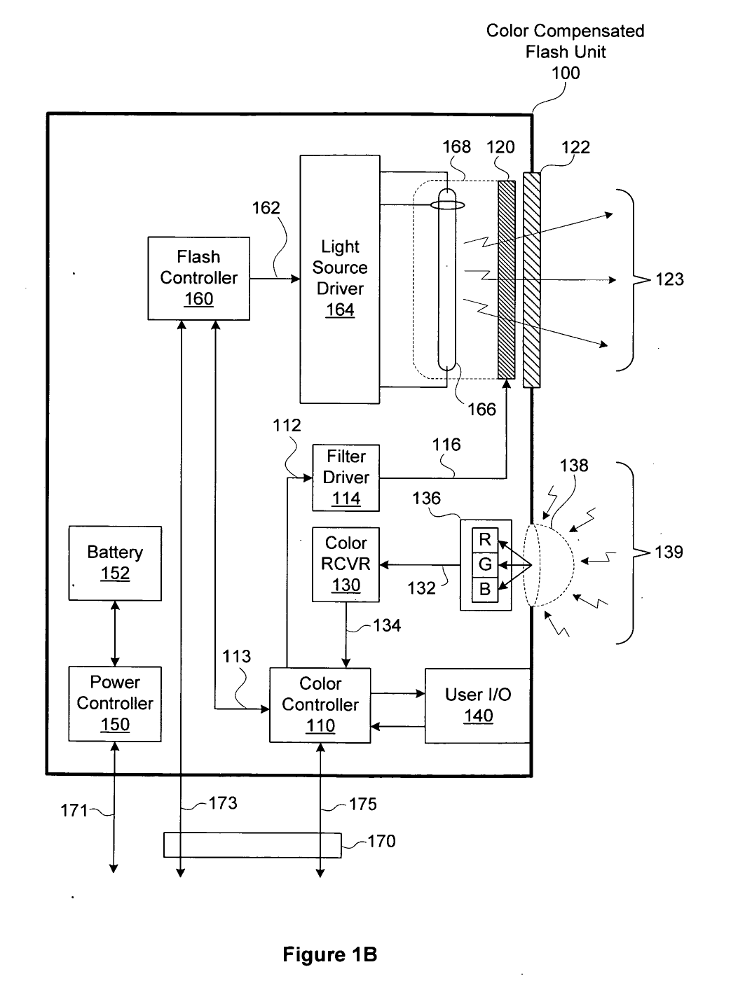

FIG. 1A illustrates a color compensated flash unit 100, according to one embodiment of the present invention. The color compensated flash unit 100 comprises an active color filter 120, an emitter lens 122, a light source 166, an ambient sampling lens 138, and an attachment module 170.

The active color filter 120 is configured to selectively pass different wavelengths of visible light, based on a set of one or more electronic control signals. The active color filter 120 is disposed between the light source 166 and the emitter lens 122. Light emitted by the light source 166 passes through the active color filter 120 and then through the emitter lens 122 to be emitted as controlled illumination 123. A reflector 168 may be configured to direct light emitted from the light source 166 towards the active color filter 120.

The ambient sampling lens 138 is configured to receive and diffuse ambient light to yield an optical signal that is representative of ambient lighting for a particular setting. Ambient light may be represented as ratios among red, green, and blue ambient light intensity. Ambient light may also be represented as having a color temperature, according to the industry standard color temperature Kelvin scale. The optical signal is sampled by a color measurement apparatus, described in greater detail below.

The attachment module 170 is configured to mechanically couple the color compensated flash unit 100 to a host device, such as a camera, a stand apparatus such as a tripod, or any other device or base. The attachment module 170 is also configured to transmit signals between the color compensated flash unit 100 and the host device. In one embodiment, the transmitted signals comprise electrical signals. In an alternative embodiment, the transmitted signals comprise electromagnetic signals. In another alternative embodiment, the transmitted signals comprise magnetic signals. In yet another alternative embodiment, the transmitted signals comprise mechanical signals. Certain of the signals may be configured to transmit commands, such as a strobe trigger command, a target strobe intensity, or a target strobe color. Persons skilled in the art will recognize that certain commands, such as a strobe trigger, are transmitted from a prior art camera to a prior art flash unit. However, prior art flash systems are not configured to receive target strobe color information. In one embodiment of the present invention, a target strobe color is transmitted to the color compensated flash unit 100. In an alternative embodiment, a measured ambient color is sampled by the color compensated flash unit 100 and transmitted to the host device.

In one embodiment, the attachment module 170 comprises a strobe “hot shoe,” the light source 166 comprises a Xenon flash tube, and the active color filter 120 comprises a liquid crystal array manufactured to include a plurality of color cells with individual light transmission characteristics controlled by the one or more electronic control signals. The emitter lens 122 comprises a Fresnel lens configured to control dispersal of the controlled illumination 123.

FIG. 1B is a functional diagram of the color compensated flash unit 100 of FIG. 1A, according to one embodiment of the present invention. Functional elements of the color compensated flash unit 100 comprise the emitter lens 122 of FIG. 1A, the active color filter 120, the light source 166, a light source driver 164, a flash controller 160, a filter driver 114, and a color controller 110. In certain embodiments, the color compensated flash unit 100 further comprises the ambient sampling lens 138, an ambient color sensor 136, a color receiver 130, user input/output (I/O) circuitry 140, a battery 152, and a power controller 150.

The light source 166 is configured to generate multi-spectral visible light, including component wavelengths of red, green and blue light. Persons skilled in the art will understand that visible light is descriptive of a range of light wavelengths spanning approximately 700 nm to 380 nm, with each color of light approximately correlated to human perception of color. Humans perceive light color according to a perception of red, green, and blue components, with a perceptive peak of red at approximately 580-620 nm, a perceptive peak of green at 535-565 nm, and a perceptive peak of blue at approximately 440-460 nm. Some individuals may perceive color slightly differently than others, however there are standard color models in the art and the meaning of red, green, and blue components is commonly accepted.

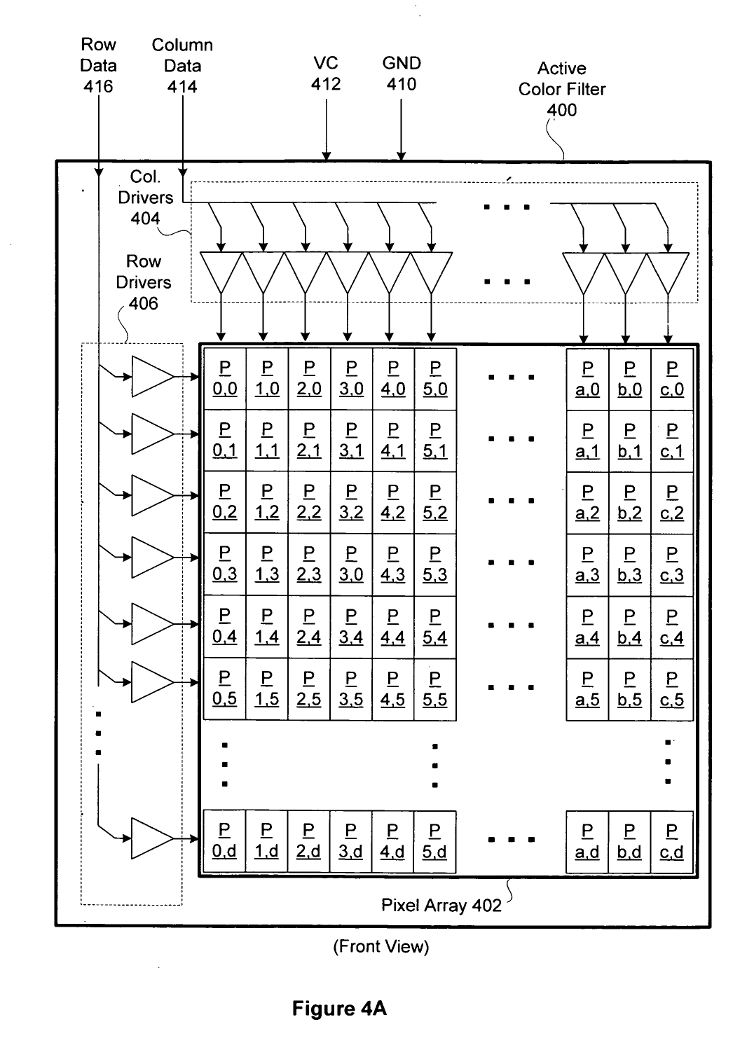

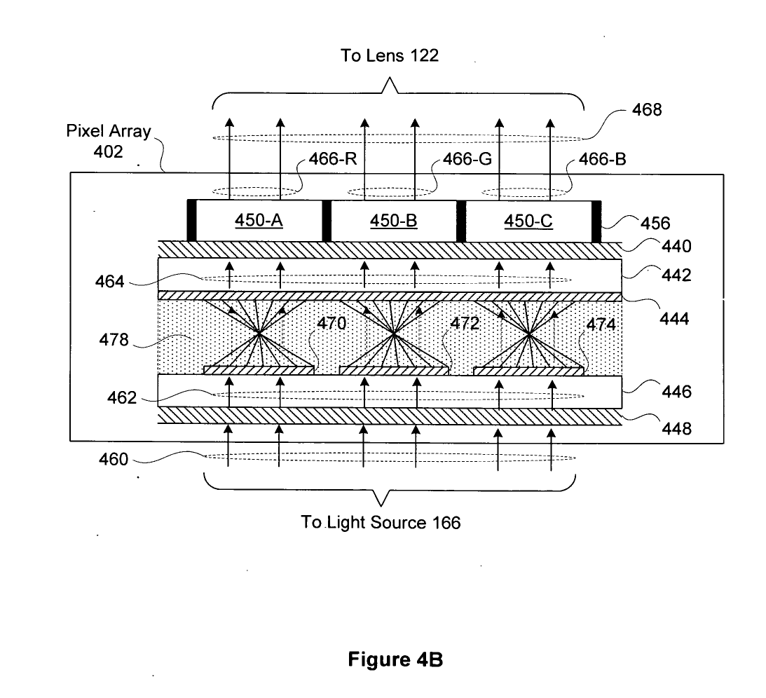

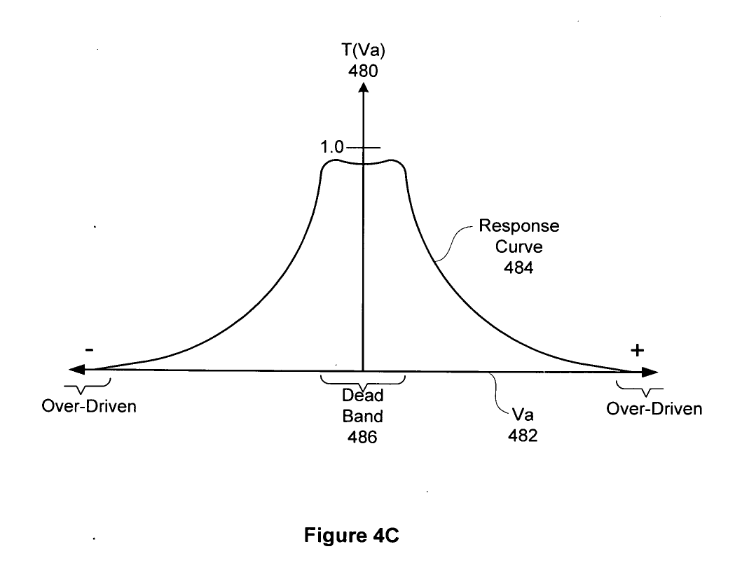

The active color filter 120 is configured to selectively pass different component colors of light generated by the light source 166, based on transmission factors transmitted in a filter control signal 116. Each transmission factor characterizes a ratio of light passed through an element of the active color filter 120 versus an amount of light made available to the element. Each color component is optically transmitted through the active color filter 120, according to a corresponding transmission factor. The active color filter 120 includes a plurality of color filter elements, each configured to respond to an associated transmission factor. The color filter elements are described in greater detail below in FIGS. 4-6. Each color filter element is configured to pass one or more color components of light. For example, one color filter element may be configured to primarily pass red light, with significant attenuation of green and blue light. A second color filter element may be configured to primarily pass green light, with significant attenuation of red and green light. A third color filter element may be configured to primarily pass yellow light, with significant attenuation of blue light, and so forth.

The active color filter 120 may employ any technically feasible technique for implementing a transmission factor for associated color components. In one embodiment, a three color (red, green, blue), multi-level liquid crystal array of pixels implements the active color filter 120. Each red, green, and blue pixel is driven to an appropriate value for a transmission factor to produce an overall light color that is suitable for a particular setting. The overall light color may be selected based on an ambient light color measurement for the setting.

The emitter lens 122 may be configured to produce a specific dispersal pattern for the controlled illumination 123. In one embodiment, the active color filter 120 is configured to be an integral component of the color compensated flash unit 100. In this embodiment, the active color filter 120 is fixed in position relative to the light source 166. In another embodiment, the active color filter 120 is configured to be movably disposed relative to the light source 166. In this embodiment, the active color filter 120 may be removed from or inserted into an optical path from the light source 166 to the controlled illumination 123. For example, the active color filter 120 may be mounted on a movable slide bearing, allowing the active color filter 120 to be positioned either in the optical path or not in the optical path. In yet another embodiment, the active color filter 120 may be detached from and reattached to the body of the color compensated flash unit 100; the emitter lens 122 may also be detached and reattached as part of a module comprising the active color filter 120 and the emitter lens 122.

The light source driver 164 generates electrical signals used to activate the light source 166. In one embodiment, the light source 166 is a Xenon flash tube, and the light source driver 164 is configured to generate a drive voltage and a trigger voltage for the Xenon flash tube. The drive voltage is typically over two hundred volts and the trigger voltage is typically in a range of several thousand volts. The drive voltage is typically supplied by a capacitor and is applied at each end of the Xenon flash tube prior to activation. A trigger voltage is applied at an offset from one end, causing the tube to be activated and to generate light. The Xenon flash tube may be extinguished by turning off the drive voltage. Activating and extinguishing the Xenon flash tube each typically take less than a millisecond. In an alternative embodiment, the light source 166 comprises at least one multi-spectral light emitting diode (LED), such as a phosphor-based white LED, and the light source driver 164 is configured to generate a driver current to activate the at least one LED. Removing the drive current extinguishes the at least one LED.

The flash controller 160 is configured to receive a host flash control signal 173 and to generate a light source control signal 162. The host flash control signal 173 may include any number of individual electrical or optical signals and may carry any technically feasible flash control protocol without departing the scope and spirit of the present invention. A simple, exemplary hot-shoe flash control protocol includes three electrical wires corresponding to a neutral (ground), a flash trigger, and a flash extinguish signal. When the flash trigger signal is driven by a host camera, the flash controller 160 causes the light source driver 164 to activate the light source 166. When the flash extinguish signal is driven by the host camera, the flash controller 160 causes the light source driver 164 to extinguish the light source 166. The flash trigger signal is driven in response to a shutter release event within the camera, and the extinguish signal is driven separately upon accumulation of sufficient light exposure. Conventional flash control protocols presently implement bidirectional communication between a flash unit and a camera, and enable sophisticated flash features beyond simply triggering and extinguishing the flash. In one embodiment, the host flash control signal 173 implements a conventional hot-shoe flash control protocol and the flash controller 160 is configured to communicate with the host device via the flash control protocol. The flash controller 160 may also transmit flash status information via internal flash control signal 113 and receive flash commands from the color controller 110 via internal flash control signal 113. The status information may include flash readiness. The internal flash control signal 113 may transmit flash commands including flash trigger and flash extinguish commands.

Ambient light 139 enters the ambient sampling lens 138 and is therein filtered to produce a representative color for the ambient light 139. The representative color is optically transmitted to the ambient color sensor 136. The ambient color sensor 136 is configured to generate an electrical ambient color signal 132 corresponding to the representative color. The electrical ambient color signal 132 includes a color component value for each color component sensed by the ambient color sensor 136. Any technically feasible technique may be used to represent each color component value without departing the scope and spirit of the present invention. For example, an analog voltage or current value may be used to represent a color component value. Furthermore, the analog voltage or current may comprise a linear representation, a logarithmic representation, or any other technically feasible representation. Alternatively, each color component value may be represented by a corresponding digital signal. In one embodiment, the ambient color sensor 136 is configured to sense red, green and blue color components and to generate the electrical ambient color signal 132 comprising independent color component values for red, green, and blue.

The color receiver 130 is configured to receive the electrical ambient color signal 132 and to generate a corresponding digital ambient color signal 134. For embodiments implementing an analog representation of the electrical ambient color signal 132, the color receiver 130 may provide amplification, current to voltage conversion, voltage to current conversion, linear to logarithmic conversion, logarithmic to linear conversion, analog-to-digital (AD) conversion, or any technically feasible combinMion thereof to generate the digital ambient color signal 134. Furthermore, the color receiver 130 may be configured to implement any non-linearity or mapping function. Any technically feasible technique may be used to implement the digital ambient color signal 134.

The color controller 110 is configured to receive the digital ambient color signal 134, a host control signal 175, or any combination thereof, and to generate a color control signal 112. The filter driver 114 receives the color control signal 112 and generates the filter control signal 116. In one embodiment, the filter driver 114 comprises a voltage translation amplifier for driving liquid crystal cells, and the active color filter 120 comprises a liquid crystal array with a plurality of independently controlled color cells. The color controller 110 computes the color control signal 112 based on the digital ambient color signal 134. In certain embodiments, the color controller 110 accounts for spectral emission characteristics of the light source 166 and transmission characteristics of the active color filter 120. For example, the light source 166 may generate a certain magnitude of light for red, green, and blue light, and the active color filter 120 is characterized as having an independent transmission factor for each of red, green, and blue light based on corresponding color control signals 112. In this example, the color controller 110 can generate color control signals 112 to produce a ratio of red, green, and blue light within the controlled illumination 123 that preserves the ratio of red, green, and blue ambient light sensed by the ambient color sensor 136.

In one embodiment, an N-bit binary integer is used to represent each transmission factor, with integer value 0 indicating minimum transmission, and an integer value of 2̂N−1 indicating maximum transmission. For an 8-bit value, N is equal to 8 and 2̂N−1 is equal to 255. Persons skilled in the art will understand that any technique for encoding and transmitting a transmission factor may be implemented without departing the scope and spirit of the present invention.

In one embodiment, the color controller 110 implements an index table for each of red, green, and blue to map an ambient light level of each color component to a corresponding component of the color control signal 112. For example, if the digital ambient color signal 134 comprises eight bits per color component (red, green, blue), and the color control signal 112 comprises eight bits per color component, then the color controller 110 would implement three index tables that each map eight bits to eight bits. The three index tables can be configured to account for arbitrary nonlinearities within the ambient sampling lens 138, ambient color sensor 136, color receiver 130, filter driver 114, active color filter 120, as well as color balance variations in the light source 166. In this way, the entire system may be calibrated based on three tables. The tables may additionally account for temperature effects, which may impact system components in varying amounts. Furthermore, the tables may additionally account for component colors being transmitted through other color filters. For example, a table configured to determine a red transmission factor for the active color filter 120 may be primarily based on relative red ambient intensity, but the table may also account for red transmission through green and blue filters by including at least a portion of the ambient components for green and blue as index values for the table.

In certain embodiments, the color receiver 130 implements sensor calibration tables or calibration parameters to map the analog representation of the electrical ambient color signal 132 to a standard set of intensity values represented in the digital ambient color signal 134. The sensor calibration tables (or parameters) are configured to map the analog representation of the electrical ambient color signal 132 to an appropriately calibrated value for the digital ambient color signal 134. The sensor calibration tables (or parameters) account for nonlinearities within the ambient sampling lens 138, ambient color sensor 136, and analog portions of the color receiver 130. The color controller 110 implements a separate set of emission calibration tables for generating the color control signal 112, comprising a color channel for each color component. In such embodiments, each color channel is processed via two tables, and the digital ambient color signal 134 represents a standard color representation that relates sensed ambient color balance to target color balance for the controlled illumination 123. Any self-consistent standard color representation may be used without departing the scope and spirit of the present invention. In certain embodiments or modes of operation, the host control signal 175 transmits a target color balance for the controlled illumination 123, in accordance with the standard color representation associated with the digital ambient color signal 134. In such embodiments, a host device, such as a digital camera, performs an ambient color balance measurement and transmits results of the ambient color balance measurement to the color controller 110 via the host control signal 175. Alternatively, the host control signal 175 is configured to transmit an ambient color balance measurement performed by the color compensated flash unit 100 to the host device. The host device may then use or record the ambient color balance measurement.

In one embodiment, user I/O circuitry 140 provides user input devices such as buttons and user output devices such as light-emitting diode (LED) indicators, an LCD display, and the like. In particular, the user I/O circuitry 140 may provide an on/off control, means for setting color temperature on the standard Kelvin scale, means for setting ratios of red to green to blue component intensities, or any combination thereof to produce a corresponding controlled illumination 123. Furthermore, the user I/O circuitry 140 may be configured to display measured ambient color temperature, measured ambient intensities or ratios of red, green, and blue color components, or any combination thereof.

The battery 152 may comprise a replaceable rechargeable battery, a fixed rechargeable battery, or replaceable primary battery. Any battery chemistry may be implemented without departing the scope of the present invention. Alternatively, a super capacitor may implemented in place of or in combination with the battery 152. Power controller 150 provides charging circuitry, as well as power management and voltage conversion and regulation functions, according to specific implementation requirements. Persons skilled in the art will understand that the power controller 150 may implement various power management techniques, according to requirements for a specific embodiment. Power signals 171 may be used to transmit power from the power controller 150 to an external device, or receive power from an external device. Power signals 171 may also convey power status between devices.

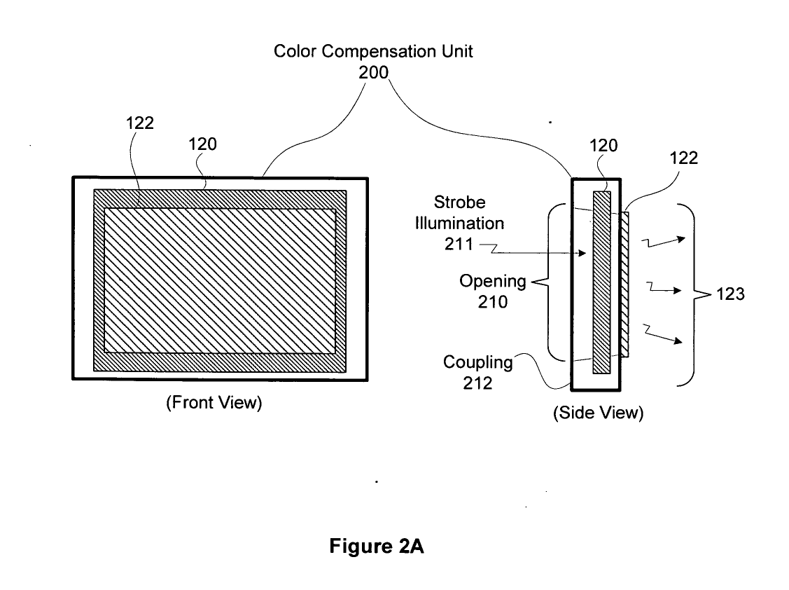

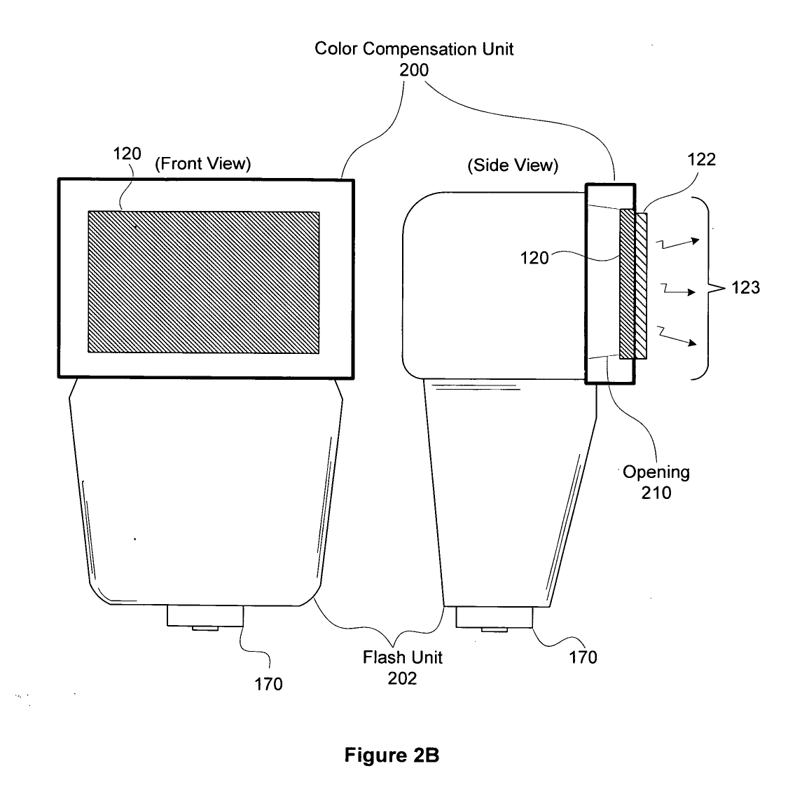

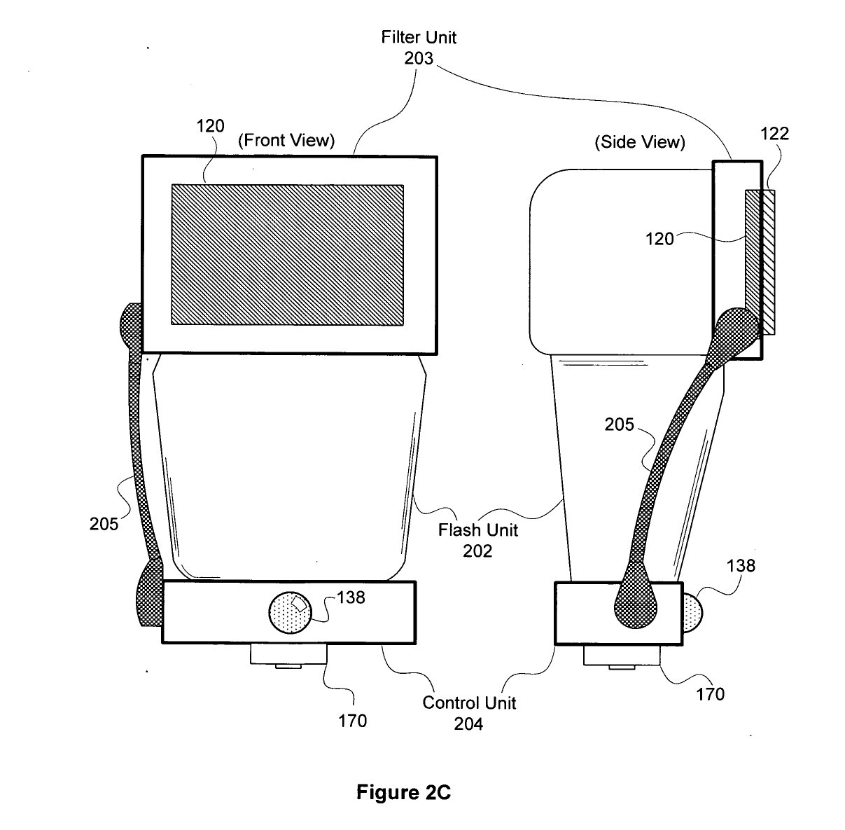

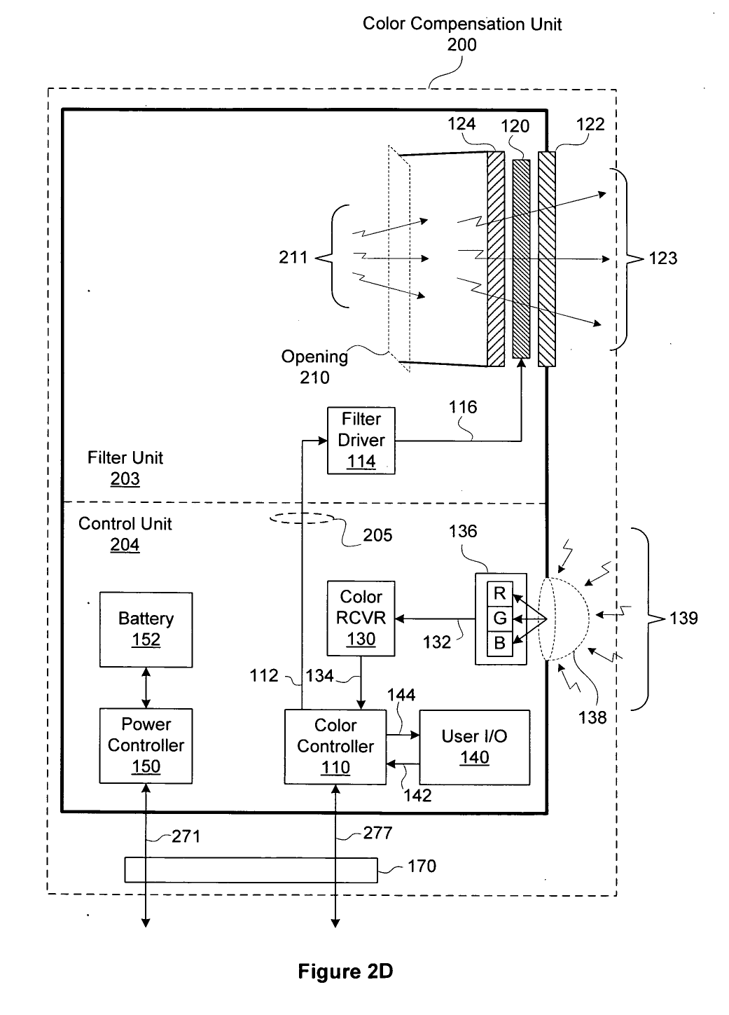

FIG. 2A illustrates a color compensation unit 200 configured to attach to a separate flash unit, according to one embodiment of the present invention. The color compensation unit 200 includes active color filter 120 of FIG. 1B, a mechanical opening 210, and a coupling 212. The color compensation unit 200 may also include emitter lens 122. The mechanical opening 210 is configured to encompass an optical output port of the separate flash unit. The coupling 212 may comprise a mechanical latch, a friction fitting, a magnetic latch, a magnetic signal connector, an optical signal connector, an electrical signal connector, a mechanical signal connector, or any combination thereof.

The separate flash unit (not shown) emits strobe illumination 211, which passes through the mechanical opening 210. The strobe illumination 211 is subsequently filtered by the active color filter 120 to yield controlled illumination 123. In one embodiment, the controlled illumination 123 is passed through emitter lens 122.

FIG. 2B illustrates the color compensation unit 200 of FIG. 2A attached to separate flash unit 202, according to one embodiment of the present invention. The mechanical opening 210 is configured to receive strobe illumination 211 generated by the flash unit 202 and transmit the strobe illumination 211 to the active color filter 120. The active color filter 120 filters the strobe illumination 211 to generate controlled illumination 123. Coupling 212 (shown in FIG. 2A) is configured to attach the color compensation unit 200 to the flash unit 202. The coupling 212 may attach using friction, magnetic attraction, a mechanical structure such as a latch, or any other technically feasible attachment means. The color compensation unit 200 may also include emitter lens 122.

The flash unit 202 may include an attachment module 170, configured to mechanically couple the flash 202 unit to a host device, such as a camera, a stand apparatus such as a tripod, or any other appropriately configured device or base. The attachment module 170 may be configured to transmit signals to the flash unit 202, for example, to trigger the flash unit 202 to generate the strobe illumination 211. The attachment module 170 may also be configured to transmit signals to the color compensation unit 200 via the flash unit 202. For example, a camera, coupled to the attachment module 170, may transmit an activation signal to the color compensation unit 200 via the attachment module 170 and flash unit 202. Any technically feasible signal may be used as an activation signal, including signals comprising electrical, electromagnetic, magnetic, or mechanical energy.

In one embodiment, the color compensation unit 200 is configured to measure ambient color and transmit results of the ambient color measurement via the coupling 212 to the flash unit 202, which further transmits the results via the attachment module 170. An attached camera or related device may receive the ambient color measurement. The ambient color measurement includes red, green, and blue color components. The ambient color measurement may be taken through ambient sampling lens 138 (not shown), using ambient color circuitry described in FIG. 1B and comprising ambient color sensor 136 and color receiver 130.

In one embodiment, color compensation unit 200 includes an electrical power source, such as a battery. In an alternative embodiment, the color compensation unit 200 draws electrical power from the flash unit 202, for example via an electrical connector within the coupling 212.

FIG. 2C illustrates a filter unit 203 and control unit 204 coupled to the separate flash unit 202, according to one embodiment of the present invention. The filter unit 203 and control unit 204 collectively implement color compensation unit 200 of FIG. 2B. Specifically, the filter unit 203 includes active color filter 120 and mechanical opening 210, and control unit 204 implements control and measurement functions of color compensation unit 200.

In one embodiment, control signals are transmitted from the control unit 204 to the filter unit 203 via control cable 205. Control cable 205 may include at least one connector (not shown) used to couple the control cable 205 to the control unit 204, the filter unit 203, or both units. In one alternative embodiment, control signals are transmitted from the control unit 204 to the filter unit 203 via a signal path within the flash unit 202. In another alternative embodiment, control signals are transmitted from the control unit 204 to the filter unit 203 via electromagnetic signaling, such as a radio-frequency signal or an optical signal path. Control unit 204 may include ambient sampling lens 138 and an ambient color measurement circuit comprising ambient color sensor 136 and color receiver 130, as described previously in FIG. 1B.

In one embodiment, the ambient color measurement circuit transmits ambient color measurement results via attachment module 170 to an attached host device, such as a camera. In alternative embodiments, the ambient color measurement circuit transmits results to a host device via a radio signal, infra-red signal, or any other technically feasible data carrying signal. The ambient color measurement circuit may also transmit ambient color measurement results to control units 204 coupled to other flash units 202.

FIG. 2D is a functional diagram of the color compensation unit 200, according to one embodiment of the present invention. As shown, the color compensation unit 200 comprises a filter unit 203 and a control unit 204. The filter unit 203 comprises active color filter 120 and mechanical opening 210. The filter unit 203 may include filter driver 114, input lens 124, and emitter lens 122. As shown, strobe illumination 211 enters the mechanical opening 210 and is filtered by the active color filter 120 to generate controlled illumination 123. Strobe illumination 211 may also pass through input lens 124. Controlled illumination 123 may also pass through emitter lens 122.

In one embodiment, color control signal 112 is transmitted via control cable 205 to the filter driver 114. The filter driver 114 generates filter control signal 116, which activates active color filter 120 to filter strobe illumination 211 into controlled illumination 123. In an alternative embodiment, filter driver 114 is disposed within the control unit 204.

Control unit 204 includes color controller 110, which is configured to generate color control signal 112 based on a target ambient color balance. Control unit 204 may also include ambient color sensor 136, color receiver 130, user I/O circuitry 140, described previously. In one embodiment, control unit 204 also includes battery 152 and power controller 150, configured to receive electrical energy from battery 152 and to generate one or more voltage supplies for the control unit 204. The power controller 150 may also generate voltage supplies for the filter unit 203. In one embodiment, power controller 150 is configured to report battery charge level associated with battery 152 to a host device via attachment module 170.

In one embodiment, color controller 110 transmits ambient color information, such as color balance measured for ambient light 139 via ambient sampling lens 138 and ambient color sensor 136, to the host device via attachment module 170. Battery charge level may be transmitted via a battery charge signal 271, while ambient color information may be transmitted via a color signal 277. Similarly, the host device may transmit color control information to the color controller 110 via color signal 277. Persons skilled in the art will understand that different techniques may be used to transmit color information from the color controller 110 to the host device, and from the host device to the color controller 110. Furthermore, the host device may be a digital camera, or any other device configured to be coupled to attachment module 170.

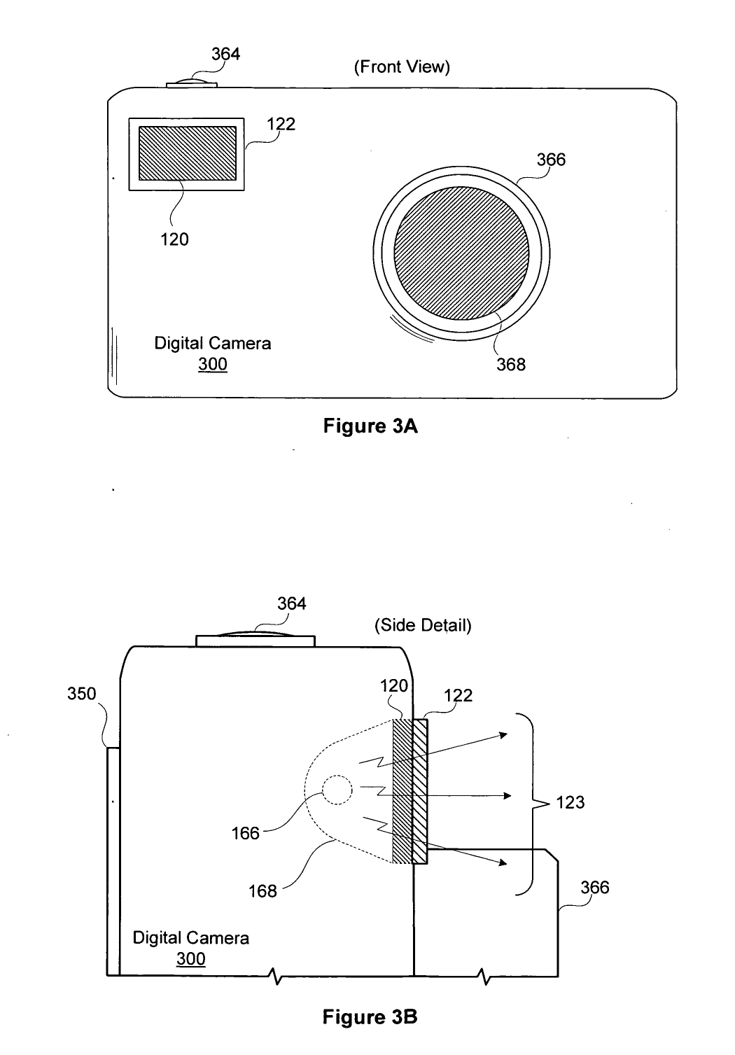

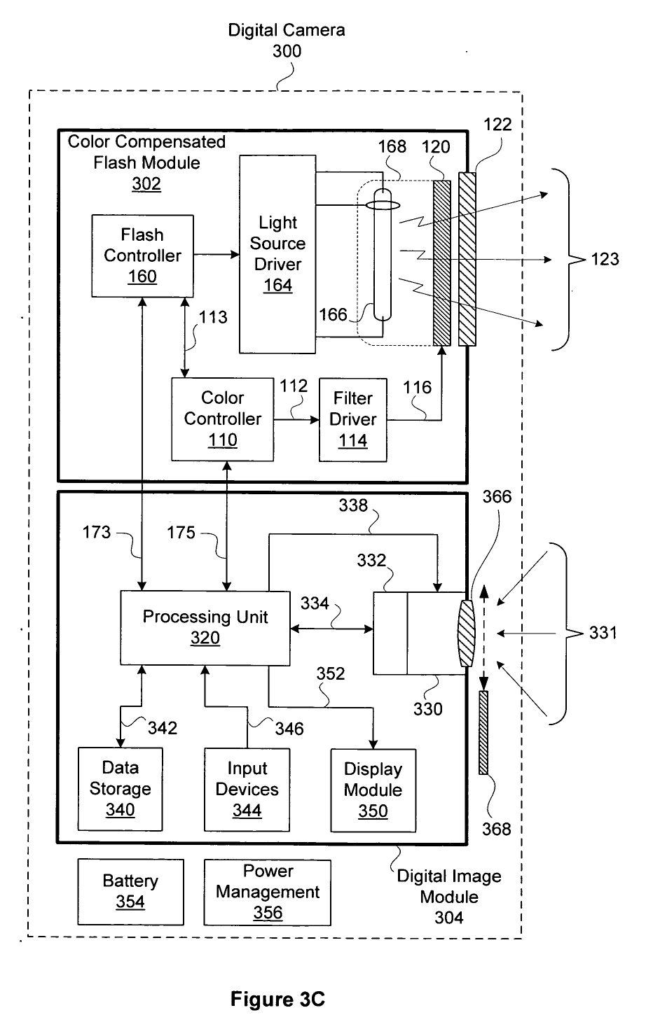

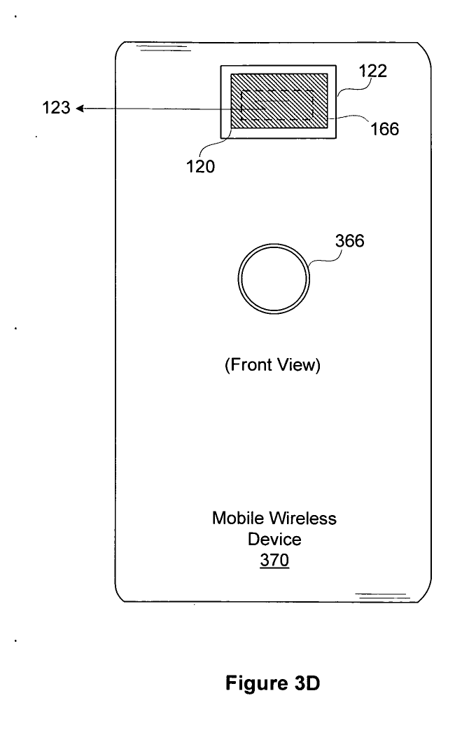

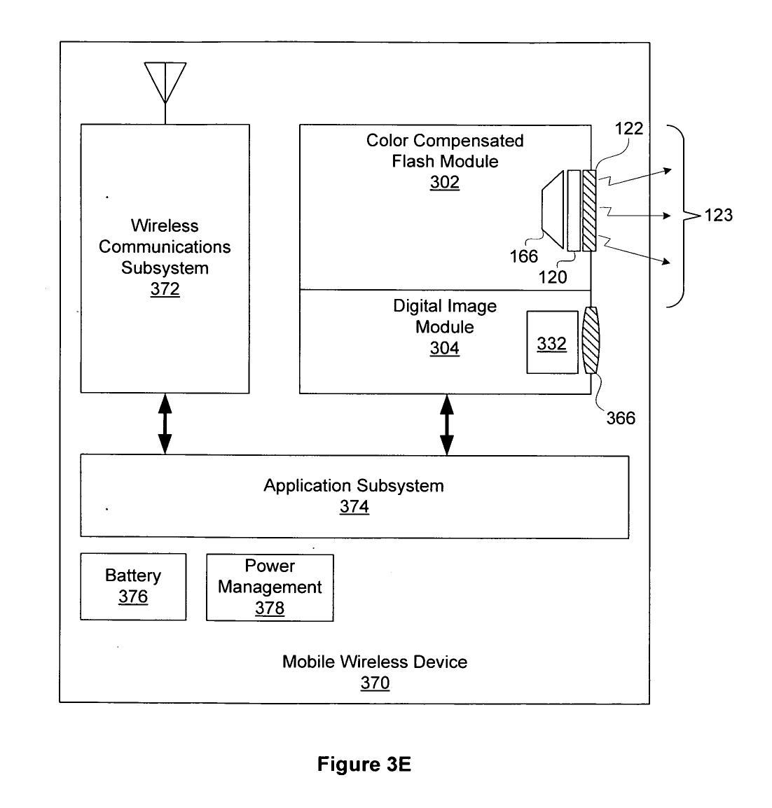

FIG. 3A illustrates a digital camera 300 configured to implement one or more aspects of the present invention. The digital camera 300 includes an image lens 366, a shutter release button 364, an image sensor (not shown) disposed behind the image lens 366, a light source (not shown), and image processing and storage circuitry (not shown). The digital camera 300 includes active color filter 120 of FIG. 1B disposed in front of the light source, as illustrated in greater detail below in FIG. 3B. The digital camera 300 may also include emitter lens 122. In one embodiment, the digital camera 300 includes an image lens cover 368 configured to cover and protect the image lens 366, for example when the digital camera 300 is turned off. The image lens cover 368 is also configured to uncover the image lens 366 when a user wishes to take a photograph with the digital camera 300.

FIG. 3B illustrates a side detail of the digital camera 300, according to one embodiment of the present invention. Light source 166 of FIG. 1B generates strobe illumination, which is filtered by active color filter 120 to generate controlled illumination 123. The controlled illumination 123 may be used to illuminate a photographic subject or enhance illumination for the photographic subject. Reflector 168 directs light from the light source 166 to the active color filter 120.

In one embodiment, the active color filter 120 is mounted in a fixed position between the light source 166 and a photographic subject (via emitter lens 122). In an alternative embodiment, the active color filter 120 is movably mounted so that it may be substantially removed from optical paths leading from the light source 166 to the photographic subject. For example, the active color filter 120 may be slid out of the optical paths, allowing unfiltered light from the light source 166 to be used to illuminate the photographic subject. The emitter lens 122 may remain in the optical paths between the light source 166 and the photographic subject.

In one embodiment, the digital camera 300 is configured to generate a photograph and to display the photograph on a display module 350, such as a liquid crystal display (LCD) screen. The camera may also present user interface objects on the display module 350. Importantly, the digital camera 300 generates a strobe of controlled illumination 123 that is filtered via active color filter 120 to conform to a color balance of ambient scene illumination for the photograph. In this way, the photograph is sampled with consistently colored illumination for a realistic, consistent appearance.

FIG. 3C illustrates a functional diagram of a color compensated flash module 302 within the digital camera 300, according to one embodiment of the present invention. The digital camera 300 comprises the color compensated flash module 302 and a digital image module 304.

The color compensated flash module 302 comprises system elements, including active color filter 120 of FIG. 1B, light source 166, light source driver 164, flash controller 160, color controller 110, and filter driver 114, each described previously in FIG. 1B. The color compensated flash module 302 may further comprise reflector 168 and emitter lens 122. As described previously in FIG. 1B, the system elements are configured to generate controlled illumination 123, characterized as having red, green, and blue color components having a color balance determined by a target color balance. The target color balance may be determined by measuring ambient color balance.

In one embodiment, the target color (white) balance is determined by digital image module 304 using any technically feasible technique and transmitted to the color controller 110 via host control signal 175. The color controller 110 generates color control signal 112 from the target color balance. In an alternative embodiment, the ambient sampling lens 138, ambient color sensor 136, and color receiver 130 of FIG. 1B are also included within the digital camera 300 and are configured to sample ambient color balance for a scene being photographed by the digital camera 300. The target color balance for the color compensated flash module 302 is computed from the sampled ambient color balance by color controller 110, which may also transmit the target color balance to the digital image module 304.

The digital image module 304 includes an electro-optical module 330, a processing unit 320, data storage unit 340, a display module 350, and input devices 344. The electro-optical module 330 comprises image lens 366, and image sensor 332. The electro-optical module 330 may also comprise focusing apparatus for focusing the image lens 366 with respect to the image sensor 332. The electro-optical module 330 may also include an iris mechanism for controlling an optical aperture for the image lens 366. The image lens cover 368 is configured to cover and protect the image lens 366 in one mechanical position, and uncover and expose the image lens cover 368 in a second mechanical position.

Optical scene information 331 is focused by the image lens 366 onto image sensor 332, which converts focused optical scene information comprising a focused image into an electrical representation of the focused image. The image sensor 332 is configured via image sensor interconnect 334. The focused image is sampled according to certain parameters, such as sensor gain and sample timing. The electrical representation of the focused image is transmitted via image sensor interconnect 334 to the processing unit 320, which formats the electrical representation of the focused image into a digital photograph for storage within data storage unit 340. Persons skilled in the art will recognize that different digital image storage formats may be used for storing the digital photograph. An electro-optical control interconnect 338 is configured to control mechanical focus and aperture actuators within the electro-optical module 330.

The processing unit 320 is configured to process and store image data from the image sensor 332. The processing unit 320 is configured to transmit image data for a given digital photograph to the data storage unit 340 via storage interconnect 342. The processing unit 320 is also configured to retrieve image data from the data storage unit 340 via the storage interconnect 342 for display on the display module 350. The processing unit 320 is configured to transmit display data to the display module 350 via display interconnect 352. The processing unit 320 is also configured to receive user commands from input devices 344 via input device signals 346. The commands may include, for example, user interface inputs, shutter release button events, and the like.

The digital camera 300 includes a power management unit 356 and a battery 354. The battery may be a fixed battery or a replaceable battery. The replaceable battery may be a primary battery or a rechargeable battery. In one embodiment, the battery 354 comprises a set of replaceable industry standard “AA” primary or rechargeable cells. The power management unit 356 is configured to receive electrical energy from the battery 354 and to generate voltage supplies for use by the digital image module 304 and the color compensated flash module 302.

In one embodiment, the target color balance is computed from the electrical representation of the focused image. The optical scene information 331 is focused by the image lens 366 onto image sensor 332, which generates the focused image having a particular red, green, and blue white balance. The focused image represents a specific region of a corresponding scene being photographed, and does not necessarily represent overall color balance for the scene.

In another embodiment, the image lens cover 368 is manufactured to be optically neutral and translucent. The image lens cover 368 is configured to transmit at least one sixteenth of all incident light comprising the optical scene information 331. The image lens cover 368 is configured to receive and diffuse ambient light to yield an optical signal that is representative of ambient color balance for a particular setting. The optical signal is sampled by the image sensor 332 as an unfocused substantially even two-dimensional signal that is representative of the overall color balance for the scene. In this embodiment, the image lens cover 368 and image lens 366 collectively function as ambient sampling lens 138 of FIG. 1B. The image sensor 332 functions as ambient color sensor 136 and color receiver 130. To sample color balance in a given scene, the digital camera 300 closes the image lens cover 368 so that only a diffuse, single color representation of the optical scene information 331 is transmitted to the image sensor 332. The image sensor 332 then samples the single color representation to determine an overall color balance for a corresponding scene. This overall color balance corresponds to the target color balance transmitted to the color compensated flash module 302. After the image sensor 332 samples the color balance of the scene, the image lens cover 368 is opened by the digital camera 300 to allow the optical scene information 331 to be focused on the image sensor 332.

Several techniques have been described herein to sample an ambient color balance, however any technically feasible technique may be used to determine and represent the ambient color balance of a scene. Importantly, the ambient color balance determines the target color balance. As described previously, the color compensated flash module 302 is configured to generate controlled illumination 123 based on the target color balance.

FIG. 3D illustrates a front view of a mobile wireless device 370 configured to implement one or more aspects of the present invention. The mobile wireless device 370 includes a digital image module, such as digital image module 304 of FIG. 3C having image lens 366. The mobile wireless device 370 also includes a color compensated flash module such as color compensated flash module 302, configured to include light source 166 and active color filter 120. The color compensated flash module 302 generates controlled illumination 123. The mobile wireless device 370 may include an emitter lens 122, configured to direct controlled illumination 123 to a photographic subject. The mobile wireless device 370 may comprise a cellular phone, an application platform, a music player, or any other computational or communications functionality.

FIG. 3E is a functional diagram of the mobile wireless device 370, according to one embodiment of the present invention. As shown, the mobile wireless device 370 includes a wireless communications subsystem 372, an application subsystem 374, a digital image module 304, a color compensated flash module 302, a battery 376, and a power management unit 378.

As described previously in FIG. 3C, the digital image module 304 is configured to receive, focus, and sample optical information and to generate a digital photograph from the optical information. Color compensated flash module 302 is configured to generate controlled illumination 123. The battery 376 may be a fixed battery or a replaceable battery. The replaceable battery may be a primary battery or a rechargeable battery. The power management unit 378 is configured to receive electrical energy from the battery 376 and to generate voltage supplies for use by the mobile wireless device 370.

In one embodiment, the wireless communications subsystem 372 comprises a digital cellular telephone subsystem. The application subsystem 374 comprises a central processing unit, data storage, an operating system configured to facilitate execution of applications, and one or more applications configured to execute on the operating system.

During normal operation of the mobile wireless device 370, a user may choose to take a photograph using mobile wireless device 370. The user activates a camera application to execute on the application subsystem 374. The camera application directs the digital image module 304 to take a photograph. The color compensated flash module 302 is triggered to generate a strobe comprising controlled illumination 123. The photograph may be stored within the mobile wireless device 370. The photograph may also be transmitted via the wireless communications subsystem 372 to an upstream server (not shown) or other users (not shown).

FIG. 4A illustrates a detailed view of an active color filter 400, according to one embodiment of the present invention. In one embodiment, at least one instance of active color filter 400 implements active color filter 120 of FIG. 1B. Active color filter 400 includes a pixel array 402, and pixel driver circuits, such as column drivers 404 and row drivers 406. The column drivers 404 are controlled according to column data 414 and the row drivers 406 are controlled according to row data 416. The column data 414 comprises intensity data for driving individual pixels P along a specified row of the pixel array 402. The row data 416 comprises row selection information to specify a particular row of the pixel array 402. The active color filter 400 is configured to accept power via VC 412 and GND 410 ports.

In one embodiment, pixels P include color filters. For example, each row of pixels P may comprise a repeating color filter pattern of red, green, and blue. In this example, pixels P(a,d), P(b,d), and P(c,d) would respectively include color filters of red, green, and blue.

FIG. 4B depicts a side view of a pixel array 402, according to one embodiment of the present invention. As shown, the pixel array 402 comprises different structural layers, including a back polarizer 448, a back substrate 446, a layer of liquid crystal material 478, column electrodes 470-474, one or more row electrodes 444, a front substrate 442, a front polarizer 440, and a filter layer 456. Protective front and back layers (not shown) may also be incorporated to protect the filter layer 456 and back polarizer 448, respectively.

In normal operation, randomly polarized light 460 from light source 166 of FIG. 1B passes through back polarizer 448 to yield polarized back light 462. The polarized back light 462 passes through column electrodes 470-474, the layer of liquid crystal material 478, the one or more row electrodes 444, and into the front substrate 442 to yield polarity modulated light 464. At each intersection of one of the column electrodes 470-474 and one of the one or more row electrodes 444, the layer of liquid crystal material 478 is able to rotate the polarity of traversing light. An electric potential applied between the column electrodes 470-474 and the one or more row electrodes 444 causes localized changes in polarization of the traversing light. The polarity modulated light 464, therefore, comprises a two-dimensional region of light having a polarity corresponding to electric potentials between the column electrodes 470-474 and the one or more row electrodes 444. The front polarizer 440 converts polarity modulated light 464 into intensity modulated light that passes through a set of color filters 450 within the filter layer 456. The color filters 450 emit intensity modulated color light 466. A group of color filters 450-A through 450-C collectively yield intensity modulated color light 468, having individually modulated color components 466-R, 466-G, 466-B. The intensity modulated color light 468 includes individually controlled red, green, and blue color intensity. In one embodiment, the intensity modulated color light 468 corresponds to controlled illumination 123.

FIG. 4C depicts a response curve 484 of light transmission T 480 as a function of applied voltage Va 482 for a cell within the pixel array 402 of FIG. 4A, according to one embodiment of the present invention. The applied voltage Va 482 corresponds to the electric potential applied between one of the column electrodes 470-474 of FIG. 4B and one of the one or more row electrodes 444. Light transmission T 480 refers to a total amount of light energy passing through a region of the pixel array 402 corresponding to an area of one pixel (intersection of one of the column electrodes 470-474 and one of the one or more row electrodes 444). As shown, approximately maximum light transmission occurs within a “dead band” 486, centered about a zero applied voltage Va 482. Increasing the applied voltage Va 482 decreases light transmission according to response curve 484, which is typically non-linear. Conventional liquid crystal materials tend to degrade when the applied voltage Va 482 is maintained in consistent polarity. Therefore, polarity of the applied voltage Va 482 should be alternated, to produce positive and negative values of Va 482.

Persons skilled in the art will recognize that any controlled transmission technology may be used to implement the pixel array 402 without departing the scope of the present invention. For example, bi-stable materials that can alternate between an opaque and clear state may be employed. Applied voltage Va 482 is then used to set a state that for a given pixel that generally persists until being set to a different state.

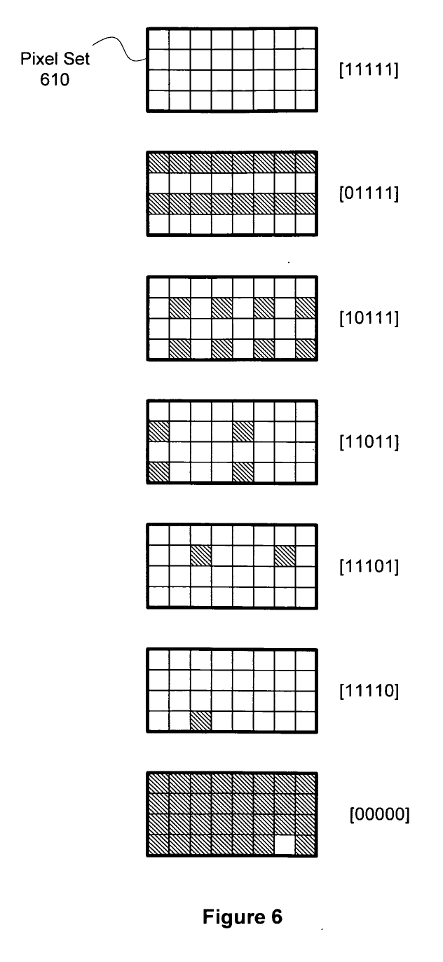

Different techniques may be used to generate different color components within the controlled illumination 123. For example, applied voltage Va 482 may be used to select an overall light transmission factor for each color filter within the pixel array 402. Alternatively, each pixel within pixel array 402 may be turned completely on or off independently to generate patterns for red, green, and blue pixels that, in aggregate, represent a target light transmission factor for each respective color. This concept is illustrated in greater detail below in FIG. 6.

In an alternative embodiment, intensity modulation is implemented using selective reflection rather than polarization modulation converted to intensity modulation by a polarizer. For example, a micro-machine reflector array is used to selectively direct light through plural color filters to generate the controlled illumination 123.

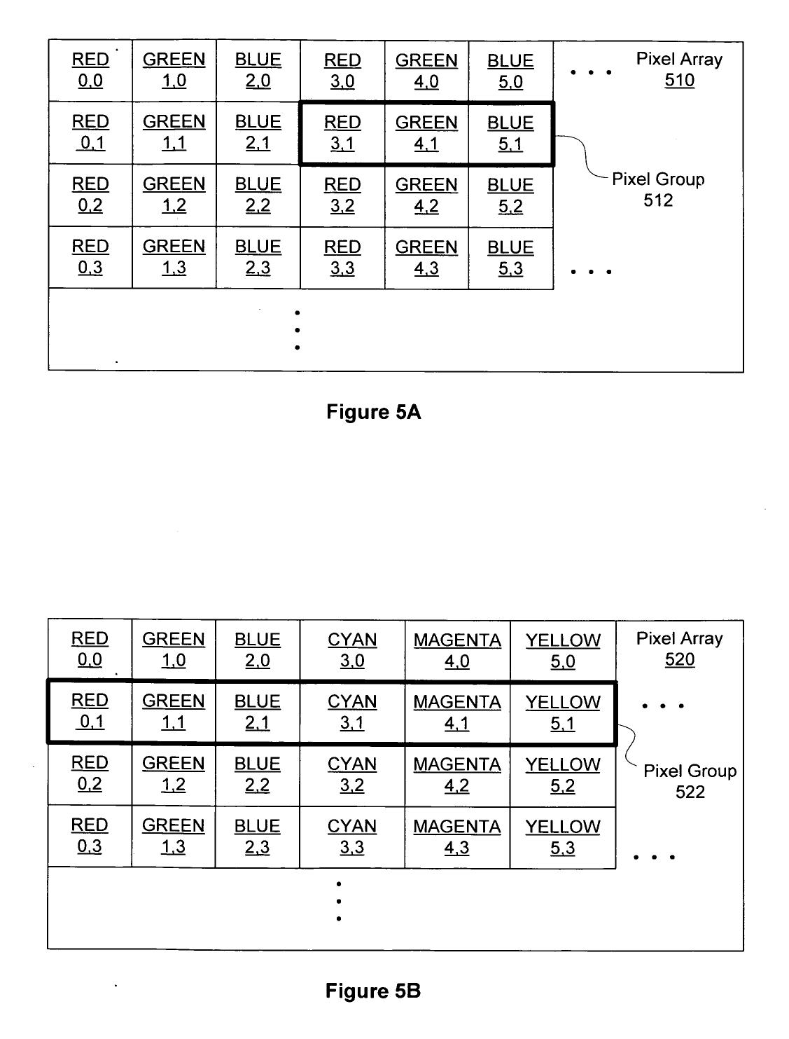

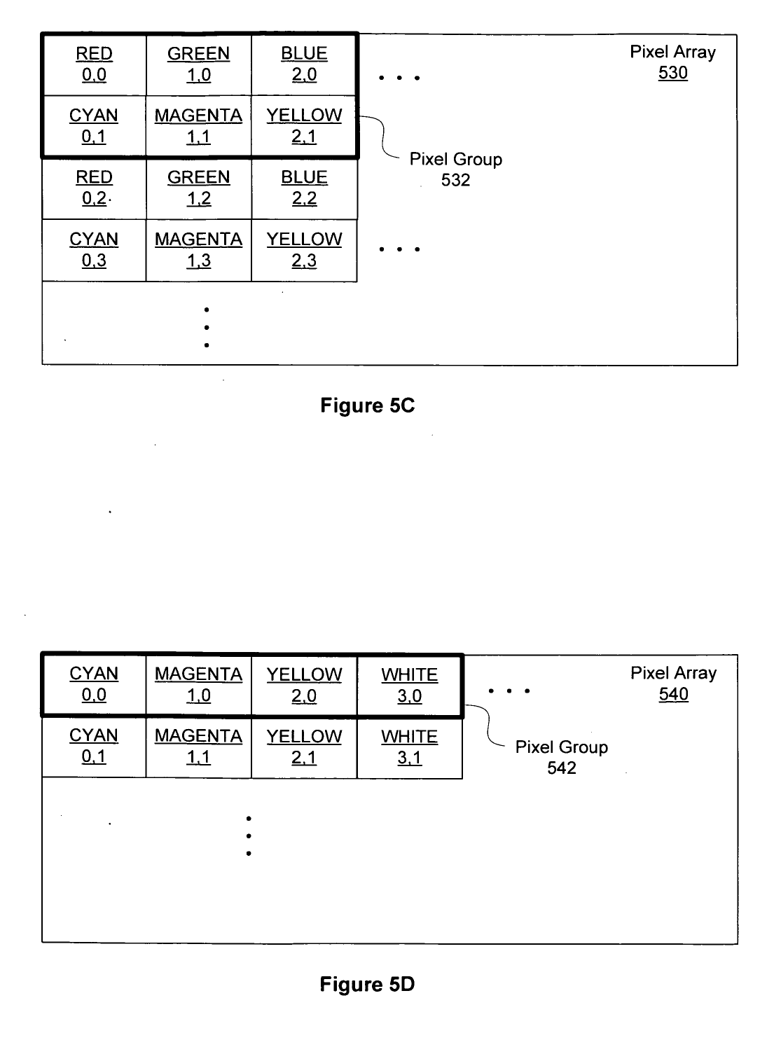

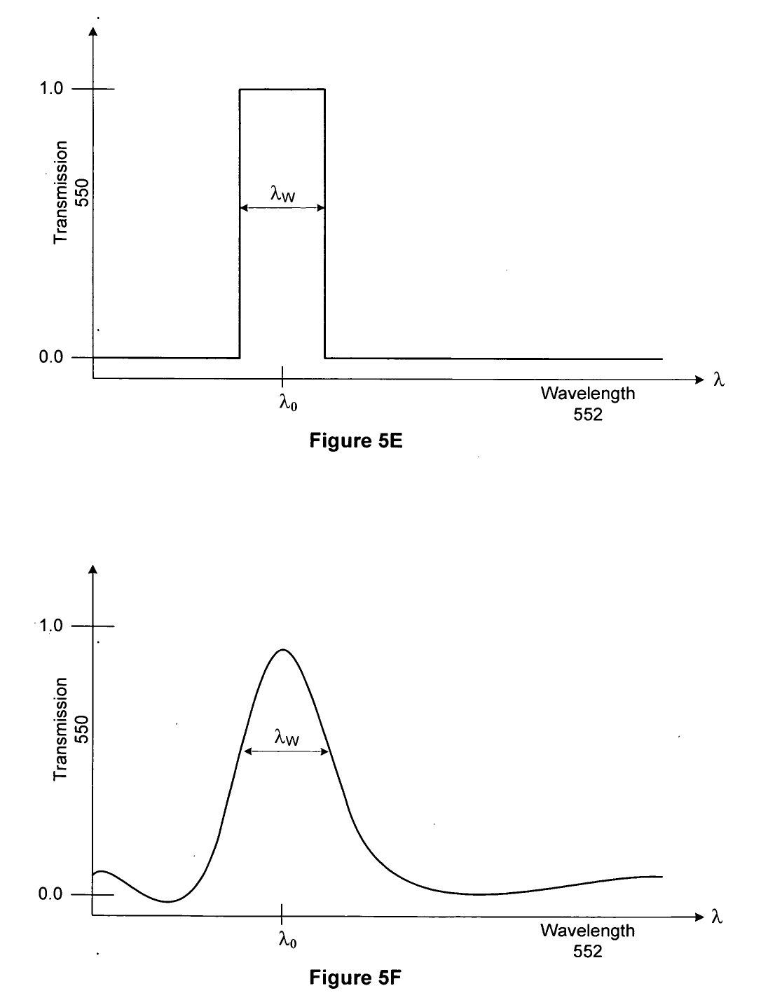

FIG. 5A illustrates the pixel array 510 configured to include color filters for red, green, and blue, according to one embodiment of the present invention. A pixel group 512 comprises one red cell (RED 3,1), one green cell (GREEN 4,1), and one blue cell (BLUE 5,1). In one embodiment, pixel array 510 corresponds to pixel array 402 of FIG. 4A, and each cell corresponds to one intersection of one of the column electrodes 470-474 of FIG. 4B, and one of the one or more row electrodes 444.

FIG. 5B illustrates the pixel array 520 configured to include color filters for red, green, blue, cyan, magenta, and yellow according to one embodiment of the present invention. A pixel group 522 comprises one red cell (RED 0,1), one green cell (GREEN 1,1), one blue cell (BLUE 2,1), one cyan cell (CYAN 3,1), one magenta cell (MAGENTA 4,1), and one yellow cell (YELLOW 5,1). In one embodiment, pixel array 520 corresponds to pixel array 402 of FIG. 4A, and each cell corresponds to one intersection of one of the column electrodes 470-474 of FIG. 4B, and one of the one or more row electrodes 444.

FIG. 5C illustrates the pixel array 530 configured to include color filters for red, green, blue, cyan, magenta, and yellow according to an alternative embodiment of the present invention. A pixel group 532 comprises one red cell (RED 0,0), one green cell (GREEN 1,0), one blue cell (BLUE 2,0), one cyan cell (CYAN 0,1), one magenta cell (MAGENTA 1,1), and one yellow cell (YELLOW 2,1). In one embodiment, pixel array 530 corresponds to pixel array 402 of FIG. 4A, and each cell corresponds to one intersection of one of the column electrodes 470-474 of FIG. 4B, and one of the one or more row electrodes 444.

FIG. 5D illustrates the pixel array 540 configured to include color filters for cyan, magenta, yellow, and white according to one embodiment of the present invention. A pixel group 542 comprises one cyan cell (CYAN 0,0), one magenta cell (MAGENTA 1,0), one yellow cell (YELLOW 2,0), and one white cell (WHITE 3,0). In one embodiment, pixel array 540 corresponds to pixel array 402 of FIG. 4A, and each cell corresponds to one intersection of one of the column electrodes 470-474 of FIG. 4B, and one of the one or more row electrodes 444.

FIGS. 5A-5D illustrate different techniques for organizing different color filters, with a goal of filtering multi-spectral light, such as from light source 166 of FIG. 1B and to generate controlled illumination 123, having a specific color balance. FIGS. 5A-5D illustrate four examples of organizing color filters, however, persons skilled in the art will recognize that any organization of color filters structured to implement active color filter 120 is within the scope and spirit of the present invention.

FIG. 5E depicts an ideal band pass color filter as a function of wavelength (λ) 552, and centered at λ₀. As shown, light transmission 550 within window λ_{w} is 1.0 (full transmission), while light transmission 550 outside the window λ_{w}, is 0.0 (no transmission). In practice, however, a color filter exhibits non-ideal characteristics, as illustrated below in FIG. 5F.

FIG. 5F depicts a typical physical realization of a band pass color filter as a function of wavelength (λ) 552, and centered at λ₀. As shown, light transmission 550 within window λ_{w} is greater than light transmission 550 outside the window λ_{w}. For example, a physical implementation of a “red” color filter will actually have imperfect transmission of red light and have non-zero transmission for green and blue light.

While practical color filters do not exhibit ideal band pass characteristics, persons skilled in the art will recognize that such filters can implement satisfactory color filtering characteristics for the purpose of implementing active color filter 120 of FIG. 1B.

FIG. 6 illustrates a technique for controlling multiple levels of transmission within an active color filter, according to one embodiment of the present invention. A pixel set 610 includes a plurality of individual pixels having substantially identical color filters. Shaded pixels represent low light transmission, while light pixels represent high light transmission. By selecting which pixels are turned on or off, an aggregate light transmission can be achieved. This technique is advantageously not sensitive to particulars of non-linear response curves, such as response curve 484 of FIG. 4C. As shown, a binary code of [00000] yields minimal light transmission, while binary code [111111] yields maximum light transmission.

The pixel set 610 may be interleaved with similar pixel sets of other colors. For example, red, green, and blue pixels may be adjacently disposed, with the red pixels belonging to a red pixel set, the green pixels belonging to a green pixel set, and so forth. The pixel set 610 may also be contiguously disposed (as shown) to create a region of the same color having controlled intensity. A plurality of such regions may comprise active color filter 120.

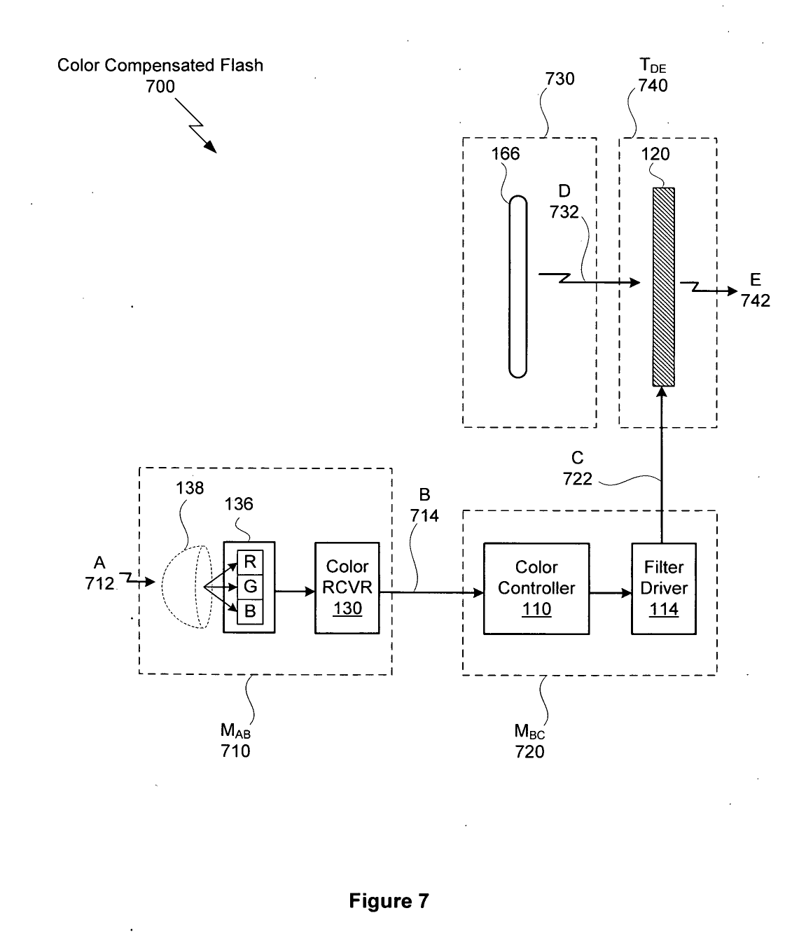

FIG. 7 is a conceptual diagram of a color compensated flash unit 700 comprising functional blocks for measuring ambient color balance and filtering a multi-spectral light signal 732 (D) to generate a controlled illumination signal 742 (E) based on ambient color balance, according to one embodiment of the present invention. The color compensated flash unit 700 comprises an ambient color measurement circuit 710, a filter controller 720, a light source 730, and an active color filter 740.

The ambient color measurement circuit 710 is configured to measure ambient light color balance from ambient light signal 712 (A) and to generate a digital ambient color signal 714 (B) based on the ambient light signal 712 (A) and a mapping function M_{AB}. The ambient light signal 712 (A) represents an optical signal (A) comprising different color components, including red, green, and blue color components (A={A_{red}, A_{green}, A_{blue}}). The digital ambient color signal 714 (B) is an electrical representation of the ambient light signal 712 (A). The digital ambient color signal 714 (B) may represent color components of the ambient light signal 712 (A) using any technically feasible technique. For example, one binary integer may be used to represent an intensity value for each color component, with a total of three binary integers used to represent red, green, and blue color components for the ambient light signal 712 (A). This may be expressed as B={B_{red}, B_{green}, B_{blue}}, where each component B_{red}, B_{green}, B_{blue} comprises one binary integer. In one embodiment, the components of B are normalized against a maximum component value (MAX{B_{red}, B_{green}, B_{blue}}).

The mapping function M_{AB} represents an abstraction of the operation of the ambient color measurement circuit 710. The mapping function M_{AB} may implement any technically feasible linear or nonlinear mapping from optical intensity to binary representation for the digital ambient color signal 714 (B). Persons skilled in the art will understand that any technique for measuring and representing ambient color may be implemented without departing the scope and spirit of the present invention.

In one embodiment, the ambient color measurement circuit 710 comprises ambient sampling lens 138 of FIG. 1B, ambient color sensor 136, and color receiver 130. Furthermore, ambient light signal 712 (A) corresponds to ambient light 139, digital ambient color signal 714 (B) corresponds to digital ambient color signal 134.

The filter controller 720 is configured to receive the digital ambient color signal 714 (B) and to generate filter control signal 722 (C). Any technically feasible mapping from the digital ambient color signal 714(B) to the filter control signal 722 (C) may be implemented without departing the scope of the present invention. In one embodiment, the filter control signal 722 (C) comprises electrical signals, such as voltage or current signals, configured to control transmission of optical color components through the active color filter 740. For example, the filter control signal 722 (C) may comprise voltage signals for driving a liquid crystal array, which selectively transmits red, green, and blue color components based on the filter control signal 722 (C). The filter controller 720 performs a mapping function M_{BC} from digital ambient color signal 714 (B) to filter control signal 722 (C). The mapping function M_{BC} is an abstraction of the operation of the filter controller 720. The mapping function M_{BC} may be configured to compensate for non-linear transmission characteristics associated with the active color filter 740.

In one embodiment, the filter controller 720 corresponds to a combination of the color controller 110 and the filter driver 114, and the filter control signal 722 (C) corresponds to filter control signal 116.

The light source 730 may implement any technically feasible technology for generating multi-spectral light. For example, the light source 730 may comprise a gas discharge chamber, such as a Xenon flash tube. Alternatively, the light source may comprise a white light emitting diode (LED), such as a white phosphor LED. In one embodiment, the light source corresponds to light source 166. The multi-spectral light is characterized by multi-spectral light signal 732 (D), comprising plural color components. In one embodiment, the multi-spectral optical signal 732 (D) is characterized as having red, green, and blue color components (D={D_{red}, D_{green}, D_{blue}}).

The active color filter 740 filters multi-spectral light signal 732 (D) to generate controlled illumination signal 742 (E) in response to filter control signal 722 (C). The active color filter 740 may implement selective transmission filters, such as commonly associated with a liquid crystal display (LCD). The active color filter 740 may also implement selective reflection filters, such as commonly associated with micro-electro-mechanical system (MEMS) based arrays used for projection displays. In one embodiment, active color filter 740 corresponds to active color filter 120, and color components of the controlled illumination signal 742 (E) comprise red, green, and blue colors (E={E_{red}, E_{green}, E_{blue}}).

The active color filter 740 may implement a set of individual color filters, based on any technically feasible set of individual colors and purity of color for each filter. A narrow (high purity) color filter has a relatively narrow wavelength transmission window λ_{w}, as illustrated in FIG. 5F. A narrow color filter will generally pass less overall light, and will appear to have a very distinct, saturated color. A wide (low purity) color filter has a relatively wide wavelength transmission window λ_{w}. A wide color filter may pass a relatively large portion of other color components. For example, a wide color filter for green predominantly passes green light, but may also pass red and blue light. A very wide color filter will generally pass more overall light, and may appear to be unsaturated or tinted rendering of a principle color.

The active color filter 740 is characterized as an optical transmission function (T_{DE}), comprising plural, independent transmission components. In one embodiment, the transmission components comprise red, green, and blue components T_{DE}={T_{red}, T_{green}, T_{blue}}). In alternative embodiments, different transmission components (e.g., cyan, magenta, and yellow) are implemented to generate a net transmission for red, green, and blue. While different variations of the active color filter 740 have been disclosed herein, persons skilled in the art will recognize that any active optical filter technology may be implemented without departing the scope and spirit of the present invention.

The color compensated flash unit 700 measures ambient light signal 712 (A) and generates controlled illumination signal 742 (E), where E≈A * k. Controlled illumination signal 742 (E) is related to ambient light signal 712 (A) by scalar coefficient k, meaning that ratios among color components are preserved between controlled illumination signal 742 (E) and ambient light signal 712 (A), although corresponding component values may be different by a constant factor of k. This overall operation is described by Equation 1, below:

E≈D·T_{DE}(M_{BC}(M_{AB}(A)))*k (Equation 1)

Persons skilled in the art will recognize that the active color filter 740 will typically transmit a given color component as a sum of net transmission of the color component through all color component filters. For example, if the active color filter 740 includes red, green and blue components and associated color component filters, then net transmission for the green component is actually a sum of the green transmission associated with the physically implemented red filter, the green transmission associated with the physically implemented green filter, and the green transmission associated with the physically implemented blue filter. This is expressed below in Equation 2:

T_{green}=t_{gr}(C_{red})+t_{gg}(C_{green})+t_{gb}(C_{blue}) (Equation 2)

In Equation 2, T_{green} represents net transmission of green light through the active color filter 740, where t_{gr} represents the net transmission of green light through the physically implemented red filter as a function of the red component of the filter control signal 722 (C_{red}), t_{gg} represents the net transmission of green light through the physically implemented green filter as a function of _{Cgreen,} and t_{gb} represents net transmission of green light through the physically implemented blue filter as a function of C_{blue}. An active color filter 740 that implements perfect, independent color filtering of each color component would have the corresponding coefficient values for green transmission: t_{gr}=0, t_{gg}=1, and t_{gb}=0. However, practical values of t_{gr}, t_{gg}, and t_{gb} should generally range from greater than zero to less than one.

Larger values for the coefficients t_{gr} and t_{gb} indicate a wider window λ_{w} shown in FIG. 5F. In certain implementations, higher coefficient values for t_{gr} and t_{gb} may be desirable because higher coefficient values indicate greater net transmission, which implies greater overall system efficiency.

Mapping functions M_{AB} and M_{BC} may comprise any technically feasible linear or non-linear transform or transforms that collectively solve Equation 1 for E≈A * k. In one embodiment, mapping function M_{BC} comprises an iterative function for solving Equation 1. For example, the mapping function M_{BC} may comprise a method that first assigns a dominant color component, based on MAX{B_{red}, B_{green}, B_{blue}}, for one component of components T_{red}, T_{green}, T_{blue}. In one implementation, the dominant color component may be set equal to a maximum value (e.g., 1.0 on a scale from 0.0 to 1.0). The mapping function M_{BC} may then assign a second to dominant color component while preserving a ratio between the dominant and second to dominant color components for both B and T. The mapping function M_{BC} may then assign a least dominant color component while preserving ratios between the dominant color component, second to dominant component, and least dominant color components for B and T. At each stage, the mapping function may iterate to maintain proper ratios for components in T.

An example mapping function M_{BC} may receive B={B_{red}, B_{green}, B_{blue}}, where MAX{B_{red}, B_{green}, B_{blue}} is B_{green}, followed by B_{red} and B_{blue}. If components in C and T are normalized to a range of 0.0 to 1.0, then C_{green} is set to 1.0, resulting in a green transmission value T_{green} of 1.0. Next, B_{red} is set to a value that results in a value of T_{red} that preserves the ratio B_{green}/B_{red green}=T_{green}/T_{red}. And so forth. Importantly, the red filter associated with T_{red} may contribute to net green light transmission. The transmission contributions for each color filter to each color may be known in advance, allowing the mapping function M_{BC} to generate an appropriate filter control signal 722 (C). In one embodiment, a direct lookup table implements mapping function M_{BC}, with components for B comprising table inputs, and components for filter control signal 722 (C) comprising table outputs. Persons skilled in the art will recognize that different techniques for solving Equation 1 may be implemented without departing the scope of the present invention.

In an alternative embodiment, digital ambient color signal 714 (B) is processed to yield a single scalar value that is descriptive of ambient color balance. A color temperature is one common scalar description of color balance. Hue is another scalar description of color. While a scalar description of ambient color balance represents a narrow gamut of possible color, this approach is broadly useful and accepted in the art. Generating the filter control signal 722 (C) from a scalar value for color balance comprises directly mapping the scalar value to each component of the filter control signal 722 (C) via a set of lookup tables or an appropriate mapping function. Such a direct mapping can account for net transmission of each component for each filter for each value of the scalar value color value.

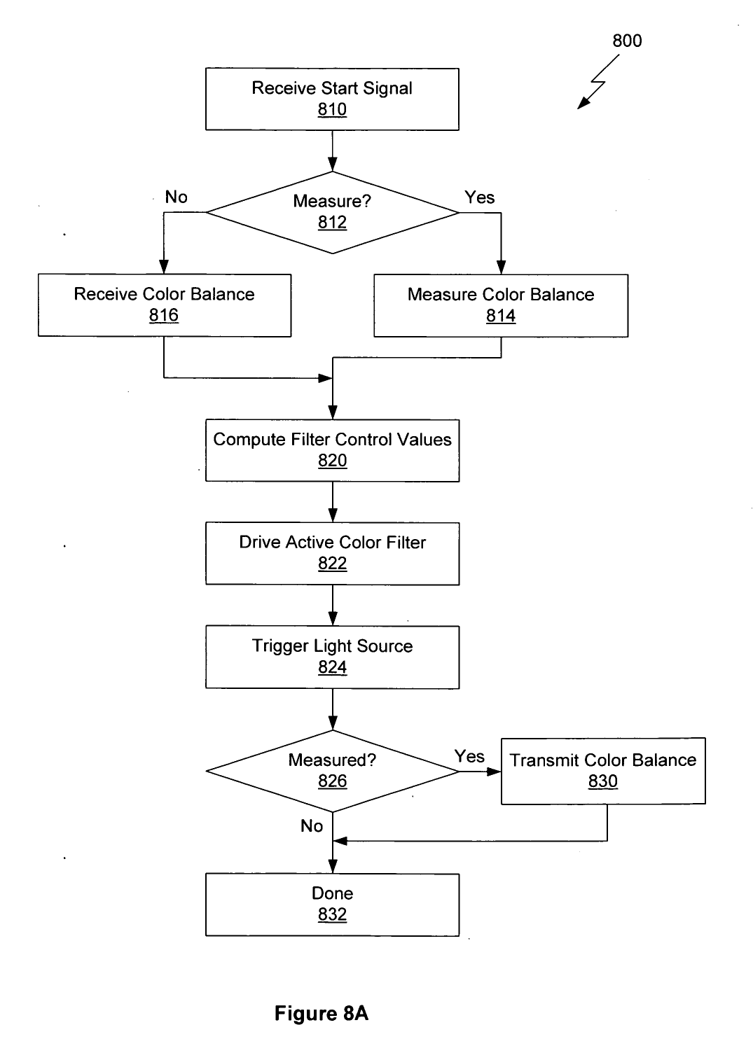

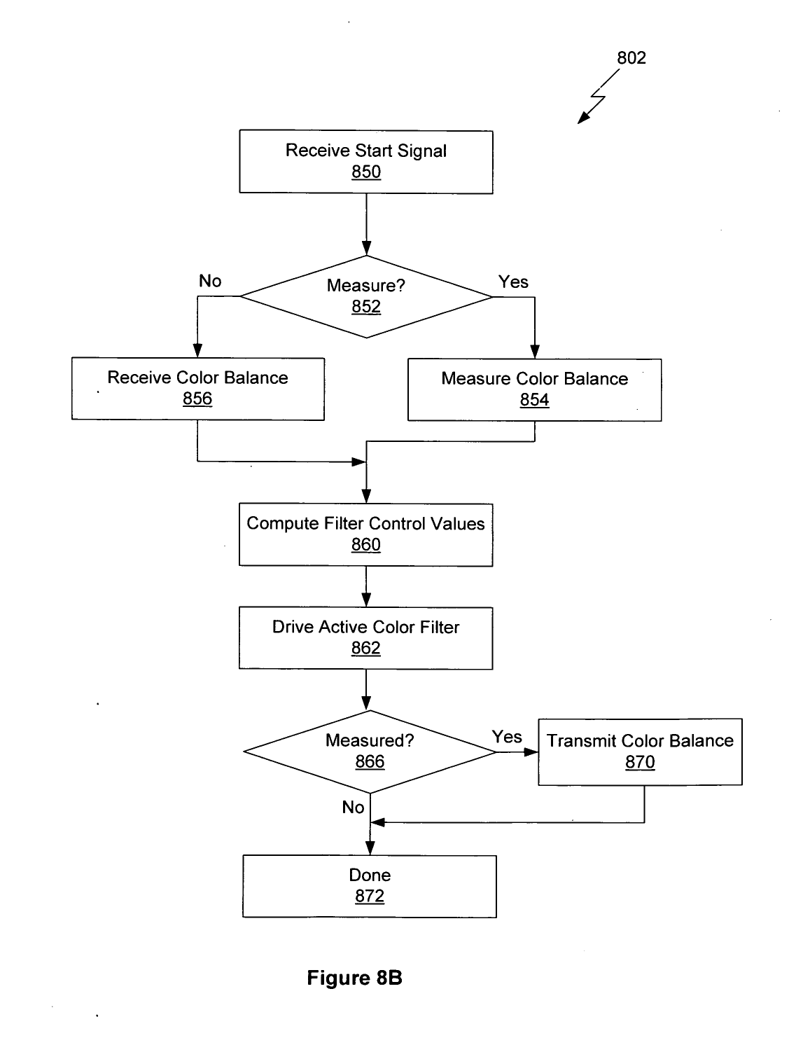

FIG. 8A is a flow diagram of method steps 800 for generating controlled illumination based on measured ambient color, according to one embodiment of the present invention. Although the method steps are described in conjunction with system FIGS. 1 B-4B, 5A-5D, and 7, persons skilled in the art will understand that any system configured to perform the method steps, in any order, is within the scope of the invention.

The method begins in step 810, where the color compensated flash unit 100 of FIG. 1B receives a start signal. The start signal indicates that the color compensated flash unit 100 should prepare for a strobe trigger by appropriately driving the active color filter 120 to match ambient color balance. If, in step 812, the color compensated flash unit 100 is directed to measure ambient color balance, then the method proceeds to step 814. The color compensated flash unit 100 may be directed to measure an ambient color balance via a user input setting from a physical control such as a button or switch, via a software user interface, or via any technically feasible input means. In step 814, the color compensated flash unit 100 measures ambient color balance to generate a measured ambient color signal.

In step 820, the color compensated flash unit 100 computes filter control values comprising a filter control signal based on the measured ambient color signal. In one embodiment, the color compensated flash unit 100 solves Equation 1 of FIG. 7 for E≈A * k . In an alternative embodiment, the color compensated flash unit 100 computes filter control values to match an ambient color temperature (scalar) value derived from the measured ambient color signal.

In step 822, the color compensated flash unit 100 drives an active color filter, such as active color filter 120, using the filter control values. In step 824, the color compensated flash unit 100 triggers a light source, such as light source 166, in response to receiving a trigger signal from a host device, such as a camera.

If, in step 826, ambient color balance was measured by the color compensated flash unit 100, then the method proceeds to step 830, where the color compensated flash unit 100 transmits a measured ambient color signal back to the host device. The method terminates in step 832.

Returning to step 826, if the ambient color balance was not measured by the color compensated flash unit 100, then the method terminates in step 832.

Returning to step 812, if the color compensated flash unit 100 is not directed to measure ambient color balance, then the method proceeds to step 816, where the color compensated flash unit 100 receives a color balance. The color balance may comprise color components (such as red, green, and blue), a color temperature value, or any other technically feasible color description. The color balance may be received from a host device, such as a camera, a physical input device, such as a button, a software user interface, or any other technically feasible means for conveying a color balance.

Although the method steps 800 are described with respect to color compensated flash unit 100, any other color filtering system having an active color filter, such as color compensation flash module 302 of FIGS. 3C and 3E, is within the scope of the present invention.

FIG. 8B is a flow diagram of method steps 802 for generating controlled illumination based on a specified color balance, according to one embodiment of the present invention. Although the method steps are described in conjunction with system FIGS. 1B-4B, 5A-5D, and 7, persons skilled in the art will understand that any system configured to perform the method steps, in any order, is within the scope of the invention.

The method begins in step 850, where the color compensation unit 200 of FIG. 2A receives a start signal. The start signal indicates that the color compensation unit 200 should begin appropriately driving the active color filter 120 to match ambient color balance. If, in step 852, the color compensation unit 200 is directed to measure ambient color balance, then the method proceeds to step 854. The color compensation unit 200 may be directed to measure an ambient color balance via a user input setting from a physical control such as a button or switch, via a software user interface, or via any other technically feasible input means. In step 854, the color compensation unit 200 measures ambient color balance to generate a measured ambient color signal.

In step 860, the color compensation unit 200 computes filter control values comprising a filter control signal based on the measured ambient color signal. In one embodiment, the color compensation unit 200 solves Equation 1 of FIG. 7 for E≈A * k . In an alternative embodiment, the color compensation unit 200 computes the filter control values to match an ambient color temperature (scalar) value derived from the measured ambient color signal.

In step 862, the color compensation unit 200 drives an active color filter, such as active color filter 120, using the filter control values. If, in step 866, ambient color balance was measured by the color compensation unit 200, then the method proceeds to step 870, where color compensation unit 200 transmits a measured ambient color signal back to a host device, such as a camera. The method terminates in step 872.

Returning to step 866, if the ambient color balance was not measured by the color compensation unit 200, then the method terminates in step 872.

Returning to step 852, if the color compensation unit 200 is not directed to measure ambient color balance, then the method proceeds to step 856, where the color compensation unit 200 receives a color balance. The color balance may comprise color components (such as red, green, and blue), a color temperature value, or any other technically feasible color description. The color balance may be received from a host device, such as a camera, a physical input device, such as a button, a software user interface, or any other technically feasible means for conveying a color balance.

Although the method steps 800 are described with respect to color compensation unit 200, any other color filtering system having an active color filter is within the scope of the present invention.

While the forgoing is directed to embodiments of the present invention, other and further embodiments of the invention may be devised without departing from the basic scope thereof, and the scope thereof is determined by the claims that follow.

We claim:

1. A method for generating color illumination having a target color balance, the method comprising:
determining the target color balance;
generating a transmission factor for each color channel of a plurality of color channels within an active color filter based on the target color balance and color characteristics of an illumination source; and
activating each color channel of a plurality of color channels based on the corresponding transmission factor to transmit illumination having the target color balance.

2. The method of claim 1, wherein the target color balance represents ratios of color intensity among red, green, and blue light.

3. The method of claim 1, wherein the step of generating comprises performing a table look-up for at least one transmission factor based on the target color balance.

4. The method of claim 1, wherein the step of activating comprises translating a transmission factor to a corresponding voltage and driving a color filter element within the active color filter using the voltage.

5. The method of claim 1, wherein the step of determining comprises:
measuring color components of ambient light; and
generating an electrical representation of the measured color components.

6. The method of claim 1, wherein the step of determining comprises receiving a predetermined target color balance.

7. The method of claim 6, wherein the predetermined target color balance is generated by a digital camera.

8. A system for generating color illumination having a target color balance, the system comprising:
an active color filter, configured to selectively transmit different color components of source illumination based on corresponding transmission factors; and
a controller, configured to:
determine the target color balance;
generate a transmission factor for each color channel of a plurality of color channels within the active color filter based on the target color balance and color characteristics of the source illumination; and
activate the active color filter using a control signal representing the transmission factors.

9. The system of claim 8, wherein the target color balance represents ratios of color intensity among red, green, and blue light.

10. The system of claim 8, wherein to generate, the controller performs a table look-up for at least one transmission factor based on the target color balance.

11. The system of claim 8, wherein to activate, the controller translates a transmission factor to a corresponding voltage and drives a color filter element within the active color filter using the voltage.

12. The system of claim 8, further comprising an ambient color sensor, configured to measure color components of ambient light.

13. The system of claim 12, wherein to determine, the controller is configured to measure color components of ambient light via the ambient color sensor.

14. The system of claim 8, wherein to determine, the controller is configured to receive a predetermined target color balance.

15. The system of claim 8, further comprising a multi-spectral light source, configured to provide the source illumination when triggered.

16. The system of claim 15, wherein the multi-spectral light source comprises a Xenon discharge device.

17. A portable photographic system, the system comprising:
a digital camera subsystem configured to sample and store photographic images;
a multi-spectral light source, configured to provide the source illumination when triggered by the digital camera subsystem;
an active color filter, configured to selectively transmit different color components of the multi-spectral light source based on corresponding transmission factors; and
a controller, configured to:
determine the target color balance;
generate a transmission factor for each color channel of a plurality of color channels within the active color filter based on the target color balance and color characteristics of the multi-spectral light source; and
activate the active color filter using a control signal representing the transmission factors.

18. The system of claim 17, wherein the digital camera subsystem is configured to compute the target color balance based on an ambient color measurement and to transmit the target color balance to the controller.

19. The system of claim 18, wherein the digital camera subsystem performs the ambient color measurement when an optically neutral lens cover is configured to cover an image lens associated with the digital camera subsystem.

20. The system of claim 17, further comprising a wireless communications subsystem that is configured to store and transmit data comprising the photographic images.
